(19) United States
(12) Patent Application Publication
(10) Pub. No.: US 2015/0301964 A1
(43) Pub. Date: Oct. 22, 2015

(54) METHODS AND SYSTEMS OF MULTI-MEMORY, CONTROL AND DATA PLANE ARCHITECTURE

(71) Applicants: ALISTAIR MARK BRINICOMBE, San Mateo, CA (US); Neil Alexander Carson, Palo Alto, CA (US); Thomas Keiser, London (GB); James Peterson, San Jose, CA (US)

(72) Inventors: ALISTAIR MARK BRINICOMBE, San Mateo, CA (US); Neil Alexander Carson, Palo Alto, CA (US); Thomas Keiser, London (GB); James Peterson, San Jose, CA (US)

(21) Appl. No.: 14/624,570

(22) Filed: Feb. 17, 2015

Related U.S. Application Data
(60) Provisional application No. 61/983,452, filed on Apr. 24, 2014.
(60) Provisional application No. 61/940,843, filed on Feb. 18, 2014.
(60) Provisional application No. 61/944,421, filed on Feb. 25, 2014.
(60) Provisional application No. 62/117,441, filed on Feb. 17, 2015.

(51) Int. Cl. G06F 13/28; G06F 3/06

(52) U.S. Cl. CPC G06F 13/28; G06F 3/061; G06F 3/0631; G06F 3/0673

(57) ABSTRACT

In one exemplary embodiment, a data-plane architecture includes a set of one or more memories that store a data and a metadata. Each memory of the set of one or more memories is split into an independent memory system. The data-planes architectures includes a storage device. A network adapter transfers data to the set of one or more memories. A set of one or mote processing pipelines transform and process the data from the set of one or more memories; wherein the the one or more processing pipelines are coupled with the one or more memories, the storage device, and wherein each of the set of one or more processing pipelines comprise a programmable block for local data processing.

### CROSS-REFERENCE TO RELATED APPLICATIONS

This application claims priority from U.S. Provisional Application No. 61/983,452, filed Apr., 24, 2014. This application is hereby incorporated by reference in its entirety for all purposes. This application claims priority from U.S. Provisional Application No. 61/940,843, filed Feb. 18, 2014. This application is hereby incorporated by reference in its entirety for all purposes. This application claims priority from U.S. Provisional Application No. 61/944,421, filed Feb. 25, 2014. This application is hereby incorporated by reference in its entirety for all purposes. This application claims priority from U.S. Provisional Application No. 62/117,441, filed Feb. 17, 2015. This application is hereby incorporated by reference in its entirety for all purposes.

### BACKGROUND

In some present data storage systems, the amount of data stored may be able to increase several fold. Network bandwidth per server may continue to increase along with the rise in intra-data-centre traffic. The number of data objects to be managed may increase as well. The storage systems that store and manage data today may be based on x.64 architecture CPUs which are failing to increase memory bandwidth in concert with the above trends.

Current data storage systems that provide full data encoding and data management capability may access data multiple times for each incoming I/O operation. Consider the case of a writing data in system 100 depicted in FIG. 1 (prior art). When this data is stored and retrieved from a memory, each arrow in FIG. 1 results in an access to and from the memory (e.g. seven accesses in total).

Consider also the case of data being read in process 200 of FIG. 2 (prior art). Here, there may be five accesses to the same piece of data. However, the read path can actually be inadequate for several reasons. For example, errors due to had drives and/or data corruption may be manifested on reads. In the case of reading a had block or rebuilding a bad drive, for a system with 24 drives, up to 24× the number of data has to be read and verified along with concurrent parity rebuilds.

Over time, the ‘compute gap’ may remain constant even as processing core performance improves. Additionally, the ‘memory gap’ may continue to grow as network bandwidths and associated storage performance continues to increase. Storage systems that provide no data management or processing capability may continue to maintain ‘up to’ 15 GB/sec non-deterministic performance by using such systems as the built-in PCIe (Peripheral Component Interconnect Express) root complexes, caches, fast network cards and fast PCIe storage devices or host-bus adapters (HBAs). In these cases, the general purpose compute cores may be providing little added value and just simply coordinating the transfer of data.

Moreover, cloud and/or enterprise customers may want advanced data management, full protection and integrity, high availability, disaster recovery, de-duplication, as well as deterministic, predictable latency and/or performance profiles that does not involve the words ‘up-to’ and have forms of quality of service guarantees associated. No storage systems today can provide this combination of performance and feature set.

### BRIEF SUMMARY OF THE INVENTION

In one exemplary embodiment, a data-plane architecture includes a set of one or more memories that store a data and a metadata. Each memory of the set of one or more memories is split into an independent memory system. The data-planes architectures includes a storage device. A network adapter transfers data to the set of one or more memories. A set of one or more processing pipelines transform and process the data from the set of one or more memories; wherein the the one or more processing pipelines are coupled with the one or more memories, the storage device, and wherein each of the set of one or more processing pipelines comprise a programmable block for local, data processing.

### BRIEF DESCRIPTION OF THE DRAWINGS

FIGS. 1-2 illustrates exemplary prior art processes.

FIGS. 3A-B depict a system for a multi-memory, control and data plane architecture, according to some embodiments.

FIG. 4 illustrates an example process for control for a data write in a multi-memory, control and data plane architecture, according to some embodiments.

FIG. 5 illustrates an example process for a flow of control for a data read, according, to some embodiments.

FIGS. 6-8 illustrate an example implementation of the systems and processes of FIG. 1-4 with custom ASICs, according to some embodiments.

FIG. 9 illustrates an example implementation of an ASIC, according to some embodiments.

FIG. 10 illustrates an example of a non-volatile memory module, according to some embodiments.

FIG. 11 illustrates an example dual ported array, according to some embodiments.

FIG. 12 illustrates an example single ported array, according to some embodiments.

FIG. 13 depicts the basic connectivity of an exemplary aspect of a system, according to some embodiments.

FIGS. 14-17 provide example scale up and mesh interconnect systems, according to some embodiments.

Example minimal metadata for deterministic access to data with unlimited forward references and/or compression are now provided in FIGS. 18-19.

FIG. 20 depicts computing system with a number of components that may be used to perform any of the processes described herein.

FIG. 21 is a block diagram of a sample computing environment that can be utilized to implement various embodiments.

The Figures described above are a representative set, and are not an exhaustive with respect to embodying, the invention.

### DESCRIPTION

Disclosed are a system, method, and article of manufacture of multi-memory, control and data plane architecture. The following, description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method Malts may or may not strictly adhere to the order of the corresponding steps shown.

Example Definitions

Application-specific integrated circuit (ASIC) can be an integrated circuit (IC) customized for a particular use, rather than intended for general-purpose use.

Direct memory access (DMA) can be a feature of computerized systems that allows certain hardware subsystems to access main system memory independently of the central processing unit (CPU).

Dynamic random-access memory (DRAM) can is a type of random-access memory that stores each bit of data in a separate capacitor within an integrated circuit.

Index node (i-node can be a data structure used to represent a file system object, which can be one of various things including a file or a directory.

Logical unit number (LUN) is a number used to identify a logical unit, which is a device addressed by the SCSI protocol or Storage Area Network protocols which encapsulate SCSI, such as Fibre Channel or iSCSI.

PCI Express (Peripheral Component interconnect Express or PCIe) can be a high-speed serial computer expansion bus standard.

Solid-state drive (SSD) can be a data storage device that uses integrated circuit assemblies as memory to store data persistently x64 CPU can the use of processors that have data-path widths, integer size, and memory addresses widths of 64 bits (eight octets).

Exemplary Methods and Systems

In one embodiment, a storage system architecture can allow delivery of deterministic performance, data-management capability and/or enterprise functionality. Some embodiments of the storage system architecture provided herein may not suffer from the memory performance gap and/or compute performance gap.

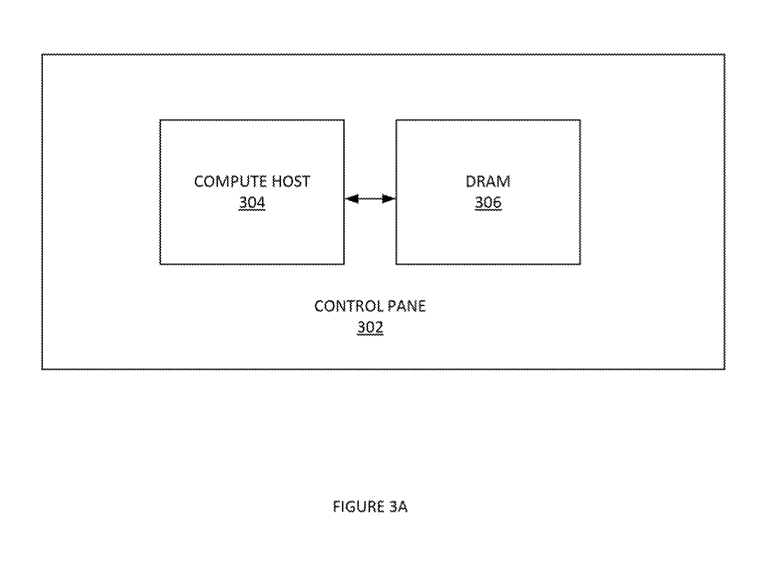

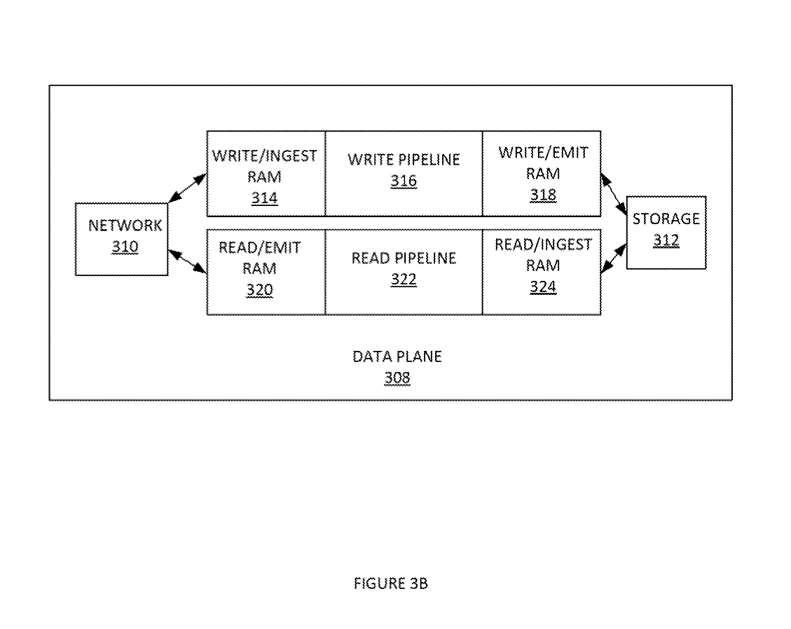

FIGS. 3A-B depict a system for a multi-memory, control and data plane architecture, according to some embodiments. FIGS. 3AB depict a storage architecture is divided into several key parts. For example, FIG. 3A depicts an example control plane 302 architecture. Control plane 302 can be the location of control flow and/or metadata processing. Control plane 302 can include compute host 304 and/or DRAM 306. Additional information about control plane 302 is provided infra. Compute host 304 can include a computing system on which general server-style compute and/or high level processing can occur. In one example, compute host 304 can be an x64 CPU. Control headers and/or metadata can be managed on computer host 304. DRAM 306 can store fixed metadata and/or paged metadata. As used herein, DRAM 306 can include a type of random-access memory that stores each bit of data in a separate capacitor within an integrated circuit.

FIG. 3B depicts an example data plane 308, according to some embodiments. Data plane 308 can be the location of architecture were data is moved and/or processed. Data plane 308 can include memories. Memories include entities where data and/or metadata can be located. Example memories include, inter alia: paged metadata memory (see DRAM 306 of FIG. 3A), fixed metadata memory (see DRAM 306 of FIG. 3A), read/ingest memory 324, read/emit memory 320, write/ingest memory 314 and/or write/emit memory 318. Data plane 308 can include one or more pipelines (e.g. a chain of data-processing stages and/or a CPU optimizations). A pipeline can be where data transformation and processing takes place. Exemplary ‘data processing steps’ are enumerated infra. Example pipeline types can include, inter alia: a write pipeline(s) 316, a read pipeline(s) 322, storage-side data transform pipeline(s), network-side data transform pipeline(s). It is noted that the metadata can be maintained (e.g. ‘lives’) in the host memory. It is further noted that the system of FIG. 3A-B does not depict the network-side data transform pipeline and/or the storage-side data transform pipeline for clarity of the figures. Data can flow through the data pipelines of data plane 308. It is noted, that in some example embodiments, Note some of these memory types (e.g. the various metadata memories) can also be placed on the control host.

The architecture the system of FIG. 3A-B can split the memories used for data processing into multiple, independent memories. This can allow a ‘divide and conquer’ approach to satisfying the aggregate memory bandwidths required by high performance storage systems with data management. Paged metadata memory can store metadata that is stored in a journaled (e.g. a file system that keeps track of the changes that will be made in a journal (usually a circular log in a dedicated area of the file system) before committing them to the main file system) and/or ‘check-pointed’ data structure that is variable in size. In one example, check-pointing can provide a snapshot of the data. A checkpoint can be art identifier or other reference that identifies the state of the data at a point in time. A storage system, as it takes more snapshots and successfully de-duplicates more data, can store more metadata (e.g. due to tracking the location of data and the like). Example metadata can include mappings from LUNs, files and/or objects stored in the system to their respective disc addresses. This metadata type can be analogous to the i-nodes and directories of a traditional file system. The metadata can be loaded on-demand with journaled changes that are periodically check-pointed back to the storage. In one example, a version that synchronously writes changes can be implemented. The total size of paged metadata can be a function of such factors as: the number of LUNs and/or files stored; the level of fragmentation of the storage; the number of snapshots taken; and/or the effectiveness of de-duplication etc.

The fixed metadata memory can store fixed-size metadata. The quantity of such metadata can be a function of the size of the back-end storage. It may contain information such as cyclic redundancy checks (CRC) for all blocks stored on the device or block remapping tables. This metadata may not be paged (e.g. because its size may be bounded).

Read/emit memory 320 can stage data before it is written to network device 310. Read/ingest memory 324 can stage data after reading from a storage device 312 before it is passed through a read pipeline 322. Write/emit memory 318 can be at the end of write pipeline 316. Write/emit memory 318 can stage data before it is written to storage device(s) 312. Write/ingest memory 314 can stage data before it is passed down write pipeline 316. If data is to be replicated to other hosts it can also be replicated back out of write/ingest memory 314.

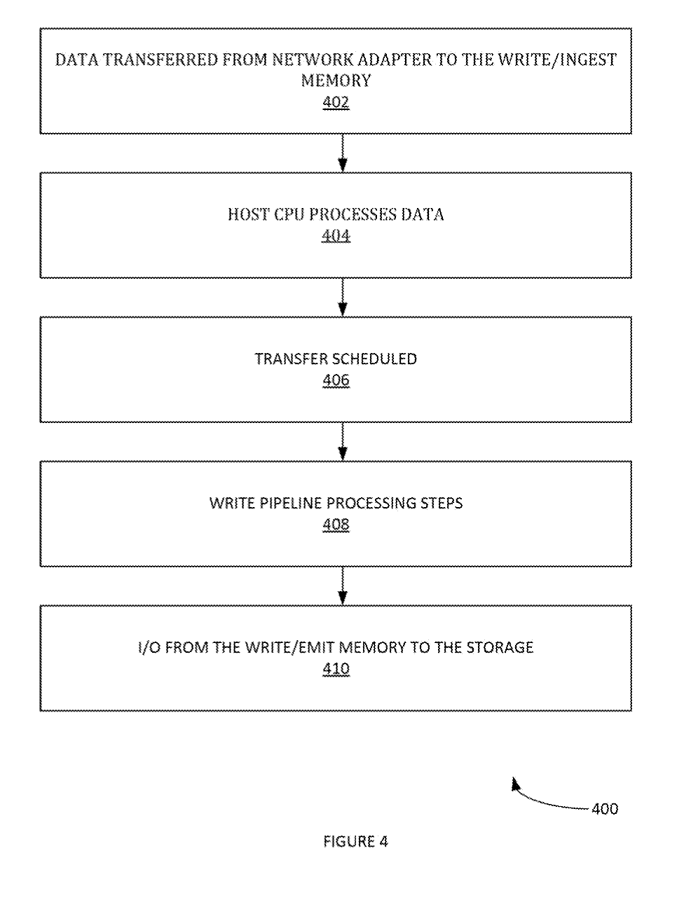

FIG. 4 illustrates an example process 400 for control of a data write in a multi-memory, control and data plane architecture, according to some embodiments. In step 402, a header(s) (e.g. SCSI, CDB and/or NFS protocol headers etc.) for the write request can be transferred from the network adapter using DMA to the host memory. The data can be transferred from a network adapter (e.g. network device 310) to the write/ingest memory (e.g. using split headers and/or data separation). In step 404, the host CPU can examine the headers, metadata mappings and/or space allocation for the write. In step 406, the transfer can be scheduled down the write pipeline. During the write pipeline, checksums can be verified. The data can be encrypted. Additionally, other data processing steps can be implemented (e.g. see example processes steps provided infra).

In step 408, the write pipeline processing steps can be performed. For example, the write pipeline can move the data from the write/ingest memory to the write/emit memory. Processing steps can be performed as the data is moved. When step 408 is complete, the host CPU can be notified that the data has arrived in the write/emit memory. In step 410, the host CPU can schedules input/output (I/O) from the write/emit memory to the storage. When step 410 is complete, a completion token can be communicated back front a network adapter.

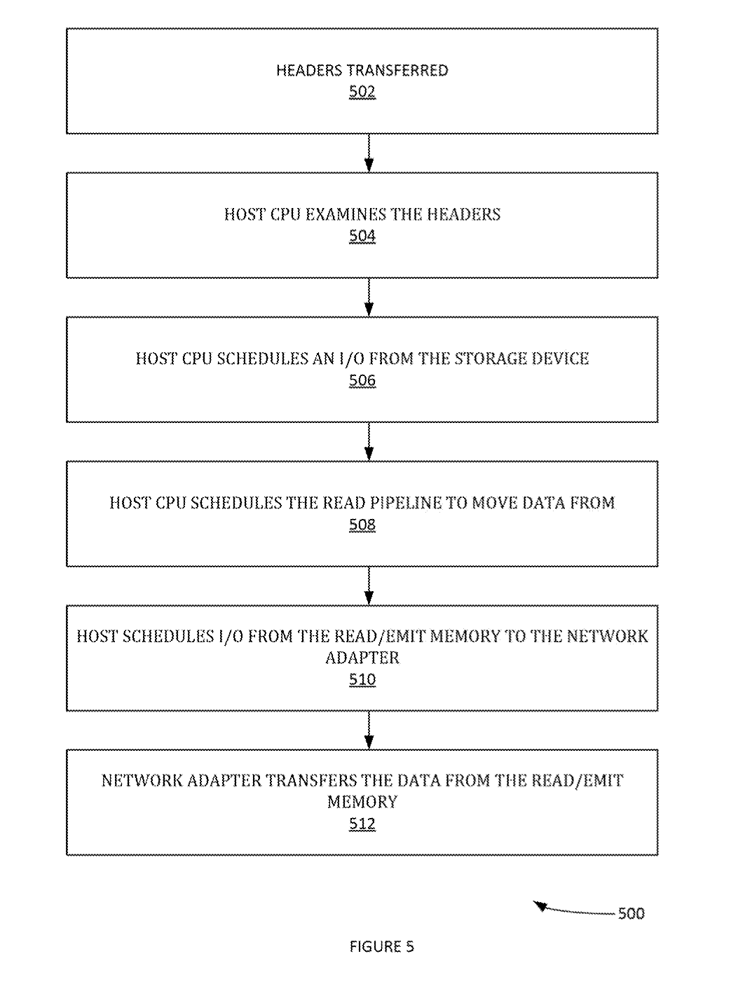

FIG. 5 illustrates an example process 500 for a flow of control for a data read, according to some embodiments. In step 502, the headers for the read request can be transferred from the network adapter (e.g. via the DMA) to the host memory. In step 504, a host CPU can examine the headers to be transferred. The host CPU can looks up the metadata mappings. The host CPU can locate the data in the relevant block, of the storage device. In step 506, the host CPU can schedule an I/O from the storage device to the read/ingest memory. In step 508, when step 506 is complete, the host CPU can schedule the read pipeline to transfer the data from the read/ingest memory to the read/emit memory. Data processing steps can also be performed during step 508. In step 510, the host CP can schedule I/O from the read/emit memory to the network adapter. In step 512, the network adapter can transfer the data from the read/emit memory and complete process 500.

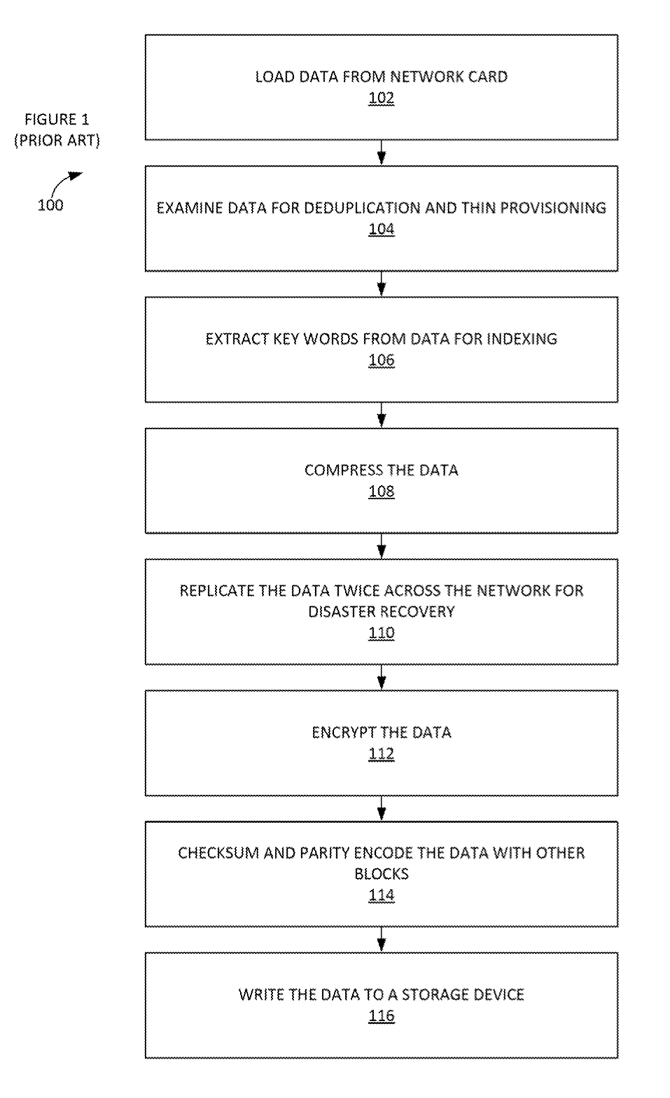

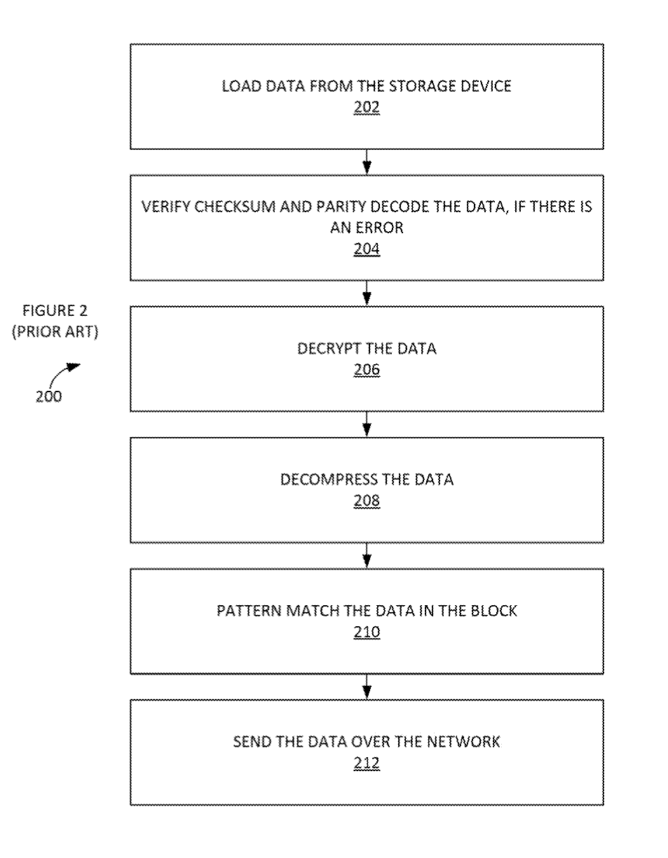

In some embodiments, the following protocols and/or devices can be used to implement the systems and processes of FIGS. 1-4 (as well as any of the processes and/or devices provided infra). These protocols and/or devices are provided by way of example and not of limitation. Example storage protocols can include SCSI/iSCSI/iSER/SRP; OpenStack SWIFT and/or Cinder; NFS (with or without pNFS front-end); CIFS/SMB 3; VMWare VVols; and/or HTTP and/or traditional web protocols (FTP, SCP, etc.). Example storage network fabrics can include fibre channel (FC4 through FC32 and beyond); Ethernet (1gE through 40gE and beyond) running iSCSI or iSER, or FCoE with optional RDMA; silicon photonics connections; Infiniband. Example storage devices can include; direct-attached PCIe SSDs based on NAND (MLC/SLC/TLC) or other technology; hard drives attached through a SATA or SAS HBA or RAID controller; direct-attached next-generation NVM devices such as MRAMs, PCMs, memristors/RRAMs and the like which can benefit from the performance of fluster memory interface vs. the standard PCIe bus; fibre channel, Ethernet or Infiniband adapters connecting to other networked storage devices using the protocols described above. Example data processing steps can include: CRC generation; secure hash generation (SHA-160, SHA-256, MD5, etc.); checksum generation; encryption (AES and other standards). Example data compression and decompression steps can include: generic compression (e.g. gzip/LZ, PAQ, bzip2 etc.); RLE encoding for text, numbers, nulls; and/or data-type-specific implementations (e.g. lossless or loss-y audio resampling, image encoding, video encoding/transcoding, format conversion). Example format-driven data indexing and search steps (e.g. where strides and parsing information is set up ahead of time) can include: keyword extraction and term counting; numeric range bounding; null/not null detection; regex matching; language-sensitive string comparison; and/or stepping across columns taking into account run lengths for vertically-compressed columnar data. Example data encoding for redundancy implementations can include: mirroring (e.g. copying of data): single parity (RAID-5), double parity (RAID-6) and triple parity encoding; generic M+N/(Cauchy)Reed-Solomon coding; and/or error correction codes such as Hamming codes, convolution codes, BCH codes, turbo codes, LDPC codes. Example data re-arrangements can include: de-fragmenting data to take out hole; and/or rotating data to go from row-based to column-based layouts or different RAID geometry conversion. Example fully programmable data path steps can include: stream processors such as ‘Tilera’ and/or Micron's Automata are allowing 80Gbit of offload today; and/or when these reach gen3 PCIe speeds one can envisage variants of the system that have fully programmable data processing steps.

In some embodiments, the systems and processes of FIGS. 1-4 can also have multiple instantiations of pipelines. Additionally, other data processing steps can be implemented, such as, inter alia: pipelines dedicated to processing data for replication, and/or pipelines dedicated to doing RAID rebuilds. Practically, systems and processes of FIGS. 1-4 can be implemented at small scale, such as in field-programmable gate array (FPGA) and/or at large scale, such as in a custom application-specific integrated circuit (ASIC). With FPGA, the bandwidths can be lower. Likewise, in some examples, intensive data processing steps may not be employed at line rates due to the lower clock rates and/or limited resources available.

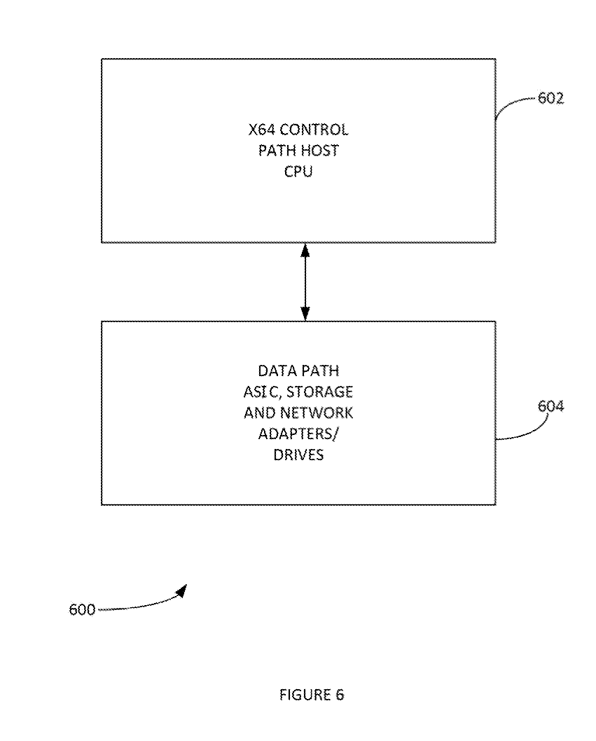

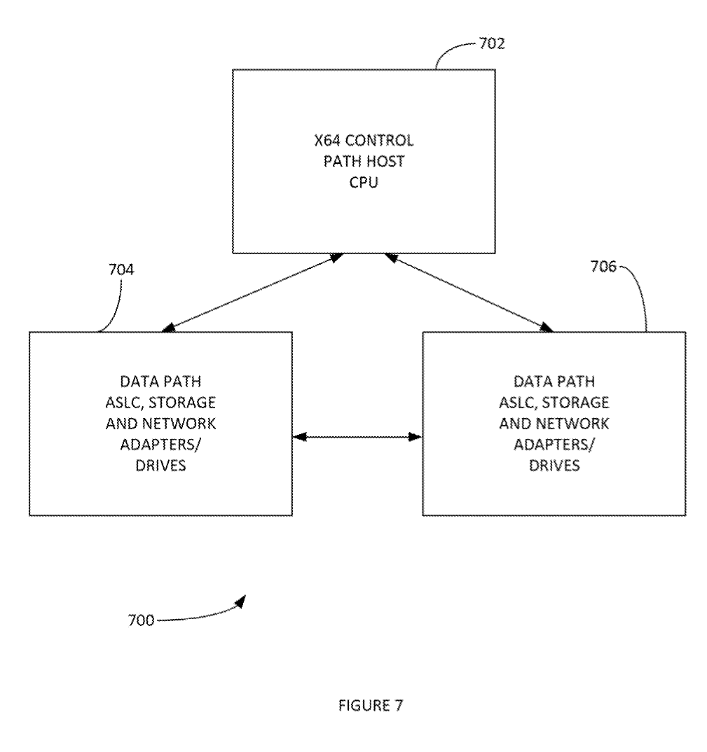

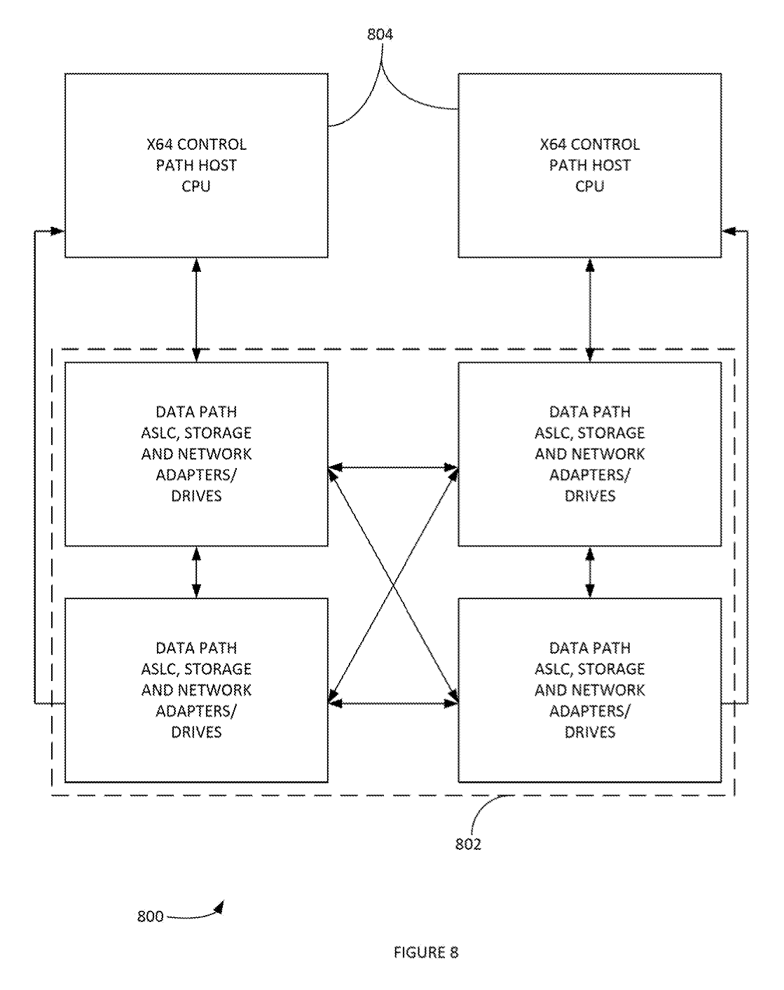

FIGS. 6-8 illustrate an example implementation of the systems and processes of FIG. 1-4 with custom ASICs, according to some embodiments. System 600 can include an x64 control path host 602, 702, 804 and various data path ASIC, storage and network adapters/drives 604, 704, 706, 802. A storage system can contain one or more ASICs. In order to aggregate the storage performance of multiple ASICs, multiple ASICs can be interconnected as illustrated in FIGS. 6-8. Each ASIC can be connected to a compute host (e.g. x64 architecture, as shown, but other architectures can be utilized in other example embodiments). The compute host can include one or more x64 CPUs. The ASICs of systems 600, 700 and/or 800 can interconnected without a central bottleneck. A fully connected mesh topology can be utilized in systems 600, 700 and/or 800. In some examples, the fully connected mesh topology can maintain maximum throughput on passive non-switched backplanes. The manner in which multiple ASICs are connected to multiple x64 control hosts is shown in FIGS. 6-8. Various example methods of ASIC interconnection are provided in systems 600, 700 and/or 800. More specifically, system 600 depicts an example one ASIC implementation. System 700 depicts an example two ASIC implementation. System 800 depicts an example four ASIC implementation. It is noted that (while not shown) mesh interconnects (e.g. with eight and/or sixteen nodes) can also be implemented. In FIGS. 6-8, the bolder lines on the diagrams represent data path mesh interconnects while the thinner dotted lines represent PCIe control path interconnects.

Each x64 processor can have compute power to run one or two ASICs in one example. In another example, multi-core chips can be used to run four or more ASICs. Each ASIC can have its own control-path interconnect to an x64 processor. A data path connection can be implemented to other ASICs in a particular topology. Because of the fully connected mesh network, bandwidth and/or performance on the data plane can be configured to scale linearly as more ASICs are added. In systems with greater than sixteen ASICs, different topologies can be utilized, such as partially connected meshes and/or switched interconnects.

Various high availability (HA) configurations can also be implemented. Production storage systems can utilize an HA system. Accordingly, HA interconnects can be peered between the systems that provide access to both PCIe drives (e.g. drives and/or storage) on a remote system, as well as, mirroring of any non-volatile memories in use. See infra for additional discussion of HA configurations.

Various control processor functions can be implemented. In one example, the control host processors can perform various functions apart from those covered in the data plane. Example cluster monitoring and/or failover/failback systems can be implemented, inter alia: integrating with other ecosystem software stacks such as VMWare, Veritas, and/or Oracle. Example high level metadata management systems can be implemented, inter alia: forward maps, reverse maps, de-duplication database, free space allocation, snapshots, RAID stripe and drive state data, clones, cursors, journaling, and/or checkpoints. Control processor functions can directing various garbage collection, scrubbing and/or data recovery/rebuild efforts. Control processor functions can free space for accounting and/or quota management. Control processor functions can manage provisioning, multi-tenancy operations, setting quality-of-service rules and/or enforcement criteria, running the high level IO stack (e.g. queue management and IO scheduling), and/or performing (full or partial) header decoding for the different supported storage protocols (e.g. SCSI CDBs, and the like). Control processor functions can implement systems management functions such as round robin data archiving, JSON-RPC, WMI, SMI-S, SNMP and connections to analytics and/or cloud-based services.

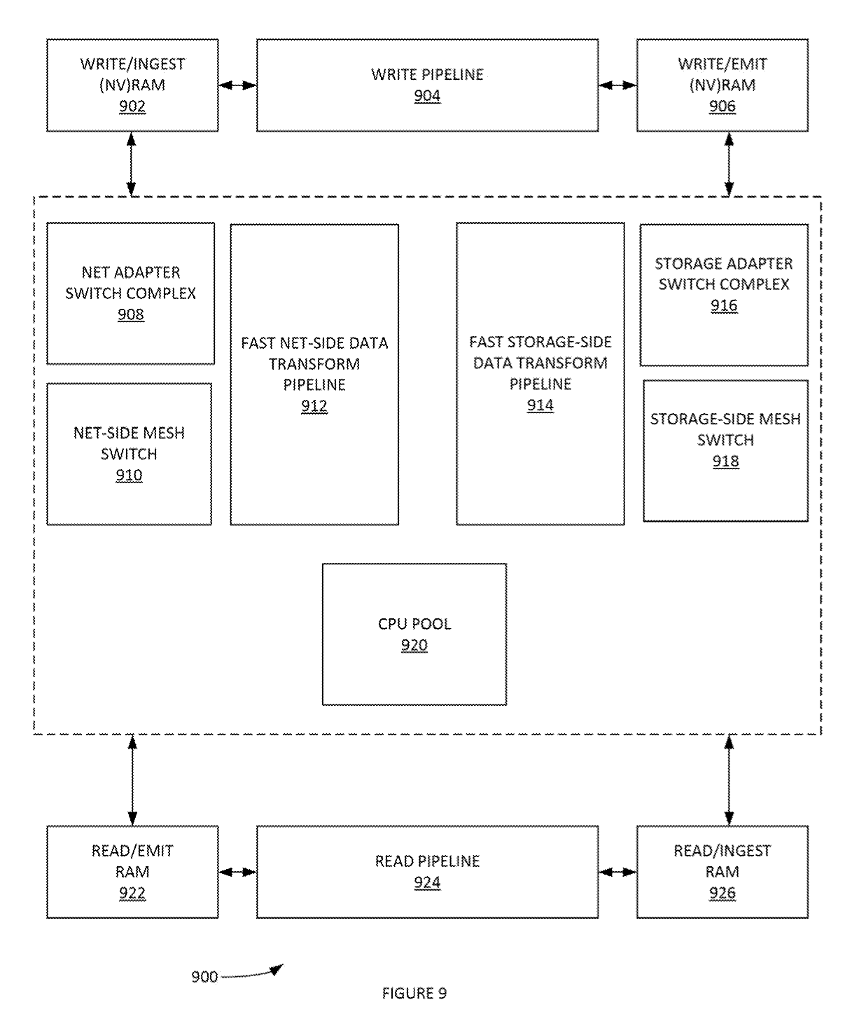

FIG. 9 illustrates an example implementation of ASIC 900, according to some embodiments. The write/ingest RAM 902 and write/emit RAM 906 of ASIC 900 can be non-volatile. The write/ingest RAM 302 and write/emit RAM 906 of ASIC 900 can provide data protection in the event of failure. In some examples only one of the write/ingest and write/emit memories of ASIC 900 can implemented as non-volatile. In one example, each RAM type can be implemented by multiple underling on-chip SRAMs (Static random-access memory) and/or off-chip high performance memories. Alternatively, one high performance set of RAM parts can implement multiple RAM types of ASIC 900.

An embedded CPU pool 920 is shown in ASIC 900. The embedded CPUs may be ARM/Tesilica and/or alternative CPUs with specified amounts of tightly coupled instruction and/or data RAMs. The processors (e.g. CPU pool 920) can poll multiple command and/or completion queues from the hosts, drives and optionally network cards. The processors can handle building the IO requests for protocols like NVMe (NVM Express) and/or SAS, coordinate the flow of IO to and from the drives, and/or manage scheduling the different pipelines (e.g. write pipeline 904 and/or read pipeline 924). The processors can also coordinate data replication and/or HA mirroring. The embedded CPUs can be connected to all blocks in the diagram, including individual data processing steps in the pipelines. Each processor can have a separate queue pair to communicate to various devices. Requests can be batched for efficiency.

The net adapter switch complex 908 and/or storage adapter switch complex 916 can include multiple PCIe switches. The net adapter switch complex 908 and/or storage adapter switch complex 916 can be interconnected via PCIe links, as well, so that the host can access both. In some examples, various devices on the PCIe switches, as well as the aforementioned bus interconnect and/or associated switches, can be accessible by the host control CPU. The on-chip CPU pool can access the same devices as well. In one example, movement of data between pipeline steps can be automated by built-in micro-sequencers to save embedded CPU load.

In some examples, some pipelines may ingest from a memory but not write the data back to the memory. These can be a variant of a read pipeline 924 that can verify checksums for data and/or save the checksums. Some pipelines may not write the resulting data into the read/emit RAM 922. In some examples, hybrid pipelines can be implemented to perform data processing. Hybrid pipelines can be implemented to save the data in order to emit memories and/or to just perform checksums and discard the data.

In one example, a small number (e.g. one or two of each data transformation pipes) of write and read pipes can be implemented. The net-side data transformation pipeline 912 can compress data for replication. The storage-side data transformation pipeline 914 can be used for data compaction, RAID rebuilds and/or garbage collection. In one version of the example, data processing steps can be limited to standard storage operations and systems (e.g. for RAID, compression, de-duplication, encryption, and the like). The net-side mesh switch 910 can be used for a data path mesh interconnect 918. Various numbers of port configurations can be implemented (e.g. 3+1 ports or 22+1 ports, the +1 being used for extra HA redundancy for non-volatile write/ingest memories or other memories). The drive-side mesh can be used for expansion trays for drives.

Example embodiments can provide different mixes of the enumerated data processing steps for different workloads. Dedicated programmable processors can be provided in the data pipeline itself. In some examples, the fixed metadata memory can implemented on, or attached to, the ASIC, with ASIC processing functions managing the fixed metadata locally. Processors on the ASIC can be configured to manage and/or update the fixed metadata memory.

For non-scale-out storage architectures, available memory capacity for metadata may be a concern. In one example, a scale-out system with separate control/data planes can be implemented. Upward scaling can also be implemented through the addition of more ASICs. A fixed metadata memory can be located on or attached to, the ASICs to relieve memory capacity on the host control processor and/or increase the maximum data capacity of the system, as the ASICs can manage the fixed metadata locally. Some storage protocol information (e.g. header, data processing and mapping look-ups) can be moved into the ASIC (or, in some embodiments, a partner ASIC). By using more powerful embedded CPUs, translation lookaside buffers (TLBs) and/or other known/recent mapping data can be maintained and looked up by the data plane ASIC. This can allow for some read requests and/or write requests to be completed autonomously without accesses by the control plane host. In one example, various functions of the control plane can be implemented on the ASIC and/or a peer (e.g. using an embedded x64 CPU). In this case, systems management, cluster and/or ecosystem integration functionality can still be run on a host x64 CPU. Additionally, in some examples, a 64-bit ARM and/or other architecture can be used for the host CPU instead of x64.

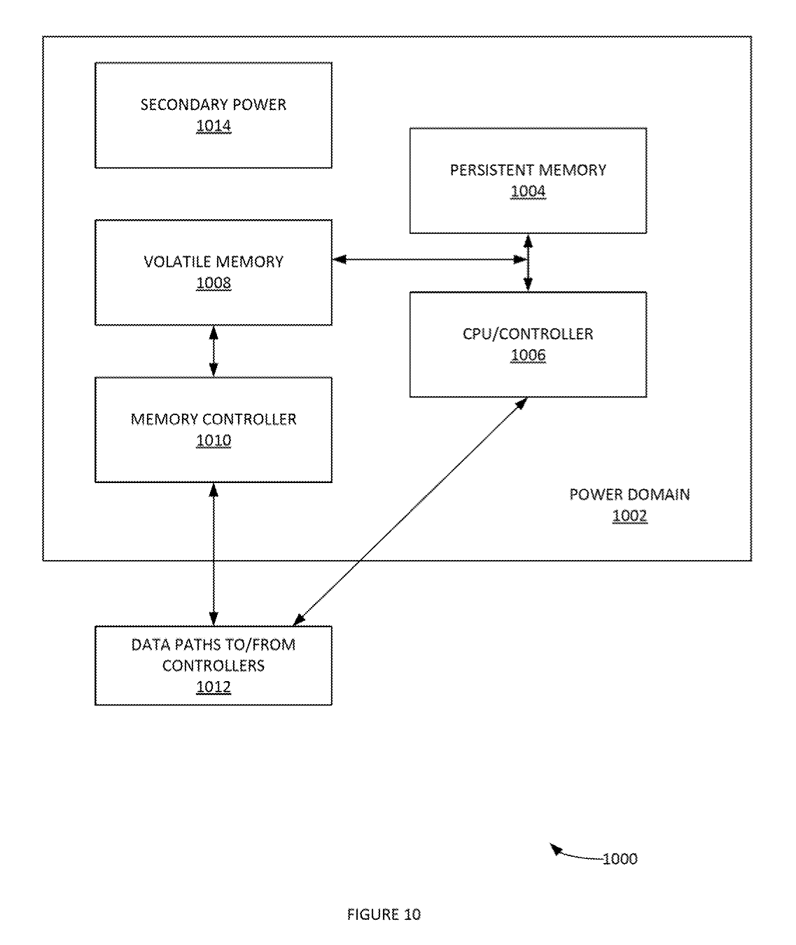

FIG. 10 illustrates an example of a non-volatile memory module 1000, according to some embodiments. In one example, non-volatile memory module 1000 can include non-volatile random access memory (NVRAM). The write/ingest buffer can serve several purposes while buffering user data such as, inter alia: hide write latency in the pipelines and/or backing store; hide latency variations in the backing store; act as a write cache; and/or act as a read cache while data is in transit to the backing store via the pipelines. Data stored in the write/ingest buffer can be, from the point of view of the clients, persisted even when the controller 1006 has not yet stored the data on the backing store. The write/ingest buffer can be large with a very high bandwidth (e.g. 1 GB to 32 GB, high bandwidth may of the order of low-hundreds of gigabytes per second). Accordingly, write/ingest buffer can be implemented using a volatile memory 1008 such as SRAM, DRAM, HMC, etc. Extra steps can be taken to ensure that the contents of this buffer are in fact preserved in the event that the system loses power.

For example, this can be achieved by pairing the buffer with a slower non-volatile memory such as NAND flash, PCM, MRAM and/or small storage device (e.g. SD card, CF card, SSD, HDD, etc.) that can provide long term persistence of the data. A CPU and/or controller 1006, power supply (e.g. battery, capacity, supercapacitor, etc.), volatile memory 1008 and/or a persistent memory 1004 can form a non-volatile buffer module with local power domain 1002 can be utilized. In the event of power loss, a secondary power source 1014 can be used to ensure that the volatile memory 1008 is powered while the contents are copied to a persistent store.

With respect to the non-volatile memory module 1000 of FIG. 10, when the system is running the persistent memory 1004 can be maintained in a clean/erased state. Non-volatile memory module 1000 can access the volatile memory 1008 as it can any other memory with the memory controller 1010 responsible for any operations required to maintain the memory fully working (e.g. refresh cycles, etc.). When a power loss event is detected, non-volatile memory module 1000 can switch over to a local supply in order to maintain the volatile memory 1008 in a functional state. The non-volatile memory module's CPU/controller 1006 can proceed to copy the data from the volatile memory 1008 into the persistent memory. Once complete, the persistent memory can be write protected. Upon power recovery, the volatile memory 1008 and/or the persistent memory can be examined and various actions taken. For example, if the volatile memory 1008 has lost power, the persistent memory can be copied back to the volatile buffer. The data can then be recovered and/or written to the backing store as it can have been before the power loss.

An example of a unified NVRAM is now provided. NVRAM can be used for more than buffering the data on the write/ingest memory. System metadata being journaled by the host can also be written to the unified NVRAM. This can ensure that journal entries are persisted to the storage media before completing the operation being journaled. This can also enable sub-sector sized journal entries to be committed safely (e.g. change vectors of only a few bytes in length).

An example of a unified NVRAM mirroring is now provided. NVRAM can provide robustness to the system when a power failure occurs the system. NVRAM can suffer data loss when there is a hardware failure in the NVRAM module (non-volatile memory module 1000). Accordingly, a second NVRAM module can act as a mirror for the primary NVRAM. Accordingly, in the event of an NVRAM failure the data can still be recovered. In some examples, data written to the NVRAM can also be mirrored from the NVRAM to the second NVRAM module. In this example, the data can be considered written and acknowledged when that mirror is complete.

Example high availability implementations are now provided. In order to mitigate downtime in the event of a hardware failure, duplicate hardware can be used to provide a backup for all hardware components ensuring that there is not a single point of failure. For example, two independent nodes, both a complete system (e.g. motherboard, CPU, ASIC, network HBAs etc.) can be tightly coupled with active monitoring to determine if one of the nodes has failed in some manner. Heartbeats between the nodes and/or the monitors can be used to assess the functional state of each node. The connection between the monitors and/or the nodes can use an independent communication method such as serial or USB rather than connecting through custom logic. The drive array can be connected in several ways as provided infra.

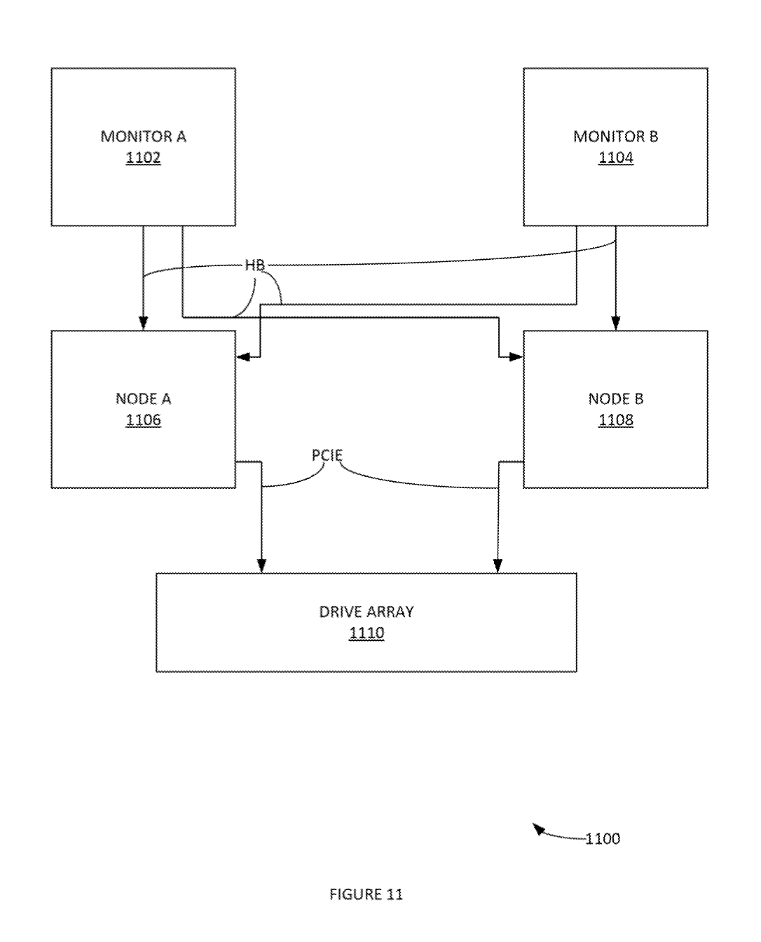

FIG. 11 illustrates an example dual ported array 1100, according to some embodiments. Dual ported array 1100 can support a pair of separate access ports. Dual ported array 1100 can include monitor A 1102, monitor B 1104, node A 1106, node B 1108 and drive array 1110. This configuration can enable a node and it's backup to have separately connected paths to the drive array 1110. In the event that a node fails, the backup node can access the drives.

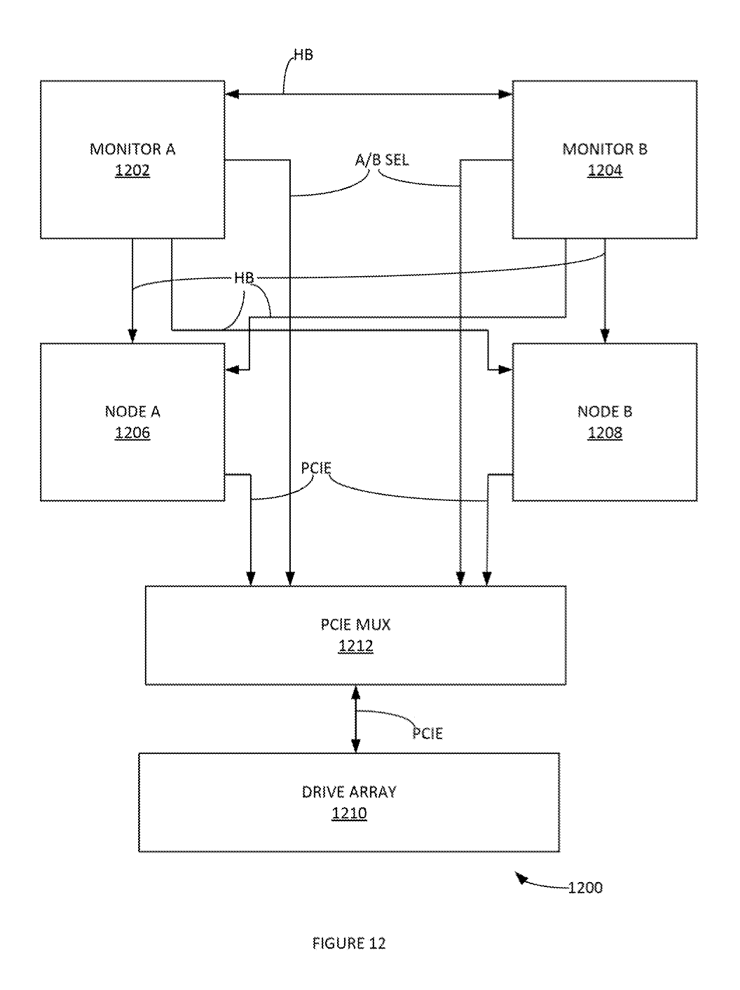

FIG. 12 illustrates an example single ported array 1200, according to some embodiments. When only a single path is available to the drive array, then access to the array can be multiplexed between the two nodes. Single ported array 1200 can include monitor A 1202, monitor B 1204, node A 1206, node B 1208, drive array 1212 and PCIe MUX (multiplexer) 1210. FIG. 12 illustrates this configuration. The monitors can determine which node has access to the array and/or controls the routing of the nodes to the array. In order to minimise the multiplexer as a source of failure, this can be managed by a passive backplane using analogue multiplexers rather than any active switching. In a highly available system, both nodes can be configured to mirror the NV RAM and each node can have access to the other node's NVRAM (e.g. in the event of a failure of a node). It is noted that mirroring between the two nodes can address this issues. For example, in the case of a failure of one node, the system can be left with no mirroring capability, thus introducing a single point of failure when in failover mode. In one example, this can be solved by sharing an extra NV RAM for the purpose of mirroring.

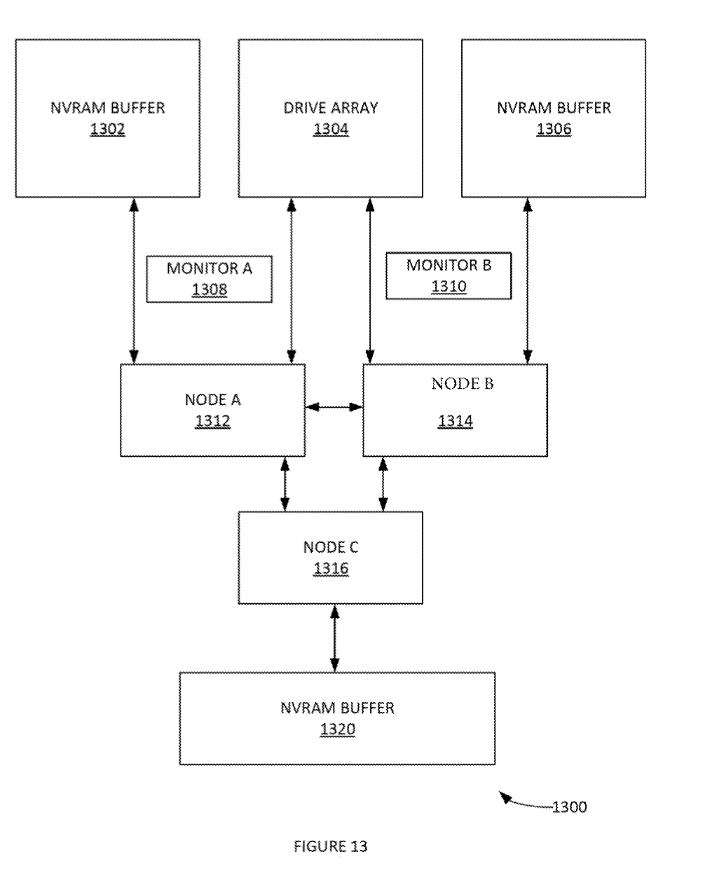

In some examples, a third ‘light’ node can be utilized. The third ‘light’ node can provides NVRAM capabilities. The term ‘light’ is utilized as this node may not be configured with access to the drive array or to the network. FIG. 13 depicts the basic connectivity, in sonic example conditions, node A can mirror NVRAM data to node C. In the event of a failure of node A 1312, node B 1314 can recover the NVRAM data from node C 1316 and then continue. Node B 1314 can use node C 1316 as a mirror node. In the event of node C 1316 failing, node A 1312 can mirror to node B 1314. In addition to be used for NVRAM mirroring when node C 1316 fails, in some examples, the link between node A 1312 and node B 1314 can be used to forward network traffic received on the standby node to the active node.

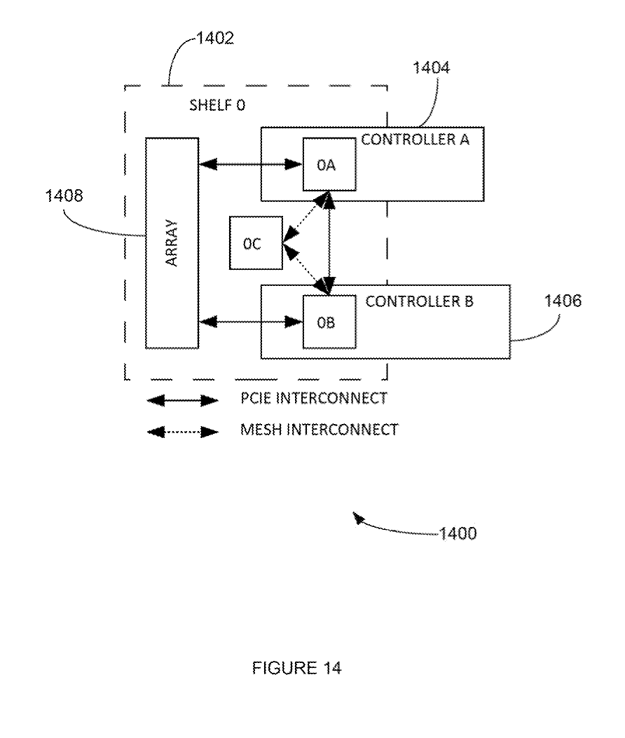

FIGS. 14-17 provide example scale up and mesh interconnect systems 1400, 1500, 1600 and 1700, according to some embodiments. The follow terminology and definitions can be utilized for some examples of the discussion of FIGS. 14-17. A node can be a data plane component. Example nodes include, inter alia: an ASIC, a memory, a processing pipelines, an NVRAM, a network interface and/or a drive array interface. An NVRAM node can be a third highly available NVRAM module (e.g. designed for at least 5-nines (99.999%) of uptime, such that no individual component failure can lead to data loss or service loss (e.g. downtime)). A shelf can be a highly available data plane unit of drives that form a RAID (Redundant Array of Independent/Inexpensive Disks) set. A controller can be a computer host for the control plane along with a number of data plane nodes.

FIG. 14 illustrates a one node configuration 1400 of an example scale up and mesh interconnect system, according to some embodiments. Two controllers (e.g. controller A 1404 and controller B 1406) can form a highly available pair with a NVRAM node C acting as the mirror. Node 0A 1404 can be the primary active node mirroring to node 0C. In the event of node 0C failing the secondary node 0B can assume the mirroring duty. In the event of node 0A failing, the secondary node can assume using node 0C as the NVRAM mirror. In the event of a second node failure, system 1400 can go offline and no data loss would occur. Additionally, the data can be recoverable as soon as a failed node is relocated. While the primary node is active, network traffic received on node 0B can be routed over to node 0A for processing.

The connections between all three nodes can be implemented in a number of ways utilizing one of many different interconnection technologies (e.g. PCIe, high speed serial, Interlaken, RapidIO, QPI, Aurora, etc.) The connection between node A and node 13 can be PCIe (e.g. utilizing non-transparent bridging) and/or manage the network host bus adapters (HBA) on the secondary node. The connections between nodes A and C, as well as, with B and C can utilize a simpler protocol than PCIe as memory transfers are communicated between these nodes.

Examples of scaling to multiple nodes are now provided. In order to scale up both storage capacity and/or network bandwidth, additional network HBAs and/or additional drive arrays can be added to the system. Additional ASICs can be connected to a single compute host allowing for increased network bandwidth through network HBAs connected to each extra ASIC and/or increased capacity by adding drive arrays to each ASIC. A single extra ASIC can be associated with a secondary ASIC for failover and another NVRAM node. Accordingly, the system can be scaled out in units of a shelf 1402 (e.g. drive array 1408, primary node, secondary node and/or NVRAM node).

In a method similar to that of ‘proxying’ the network requests from the secondary node, a controller may also can move data between nodes. For example, more high speed interconnects between the ASICs can be used to move data between different RAM buffers. As the number of shelves increase, the nodes within a controller can have a direct connection (e.g. in the case of implementing a fully-connected mesh) to every other node in order to increase bandwidth in the event of bottlenecks and/or latency issues.

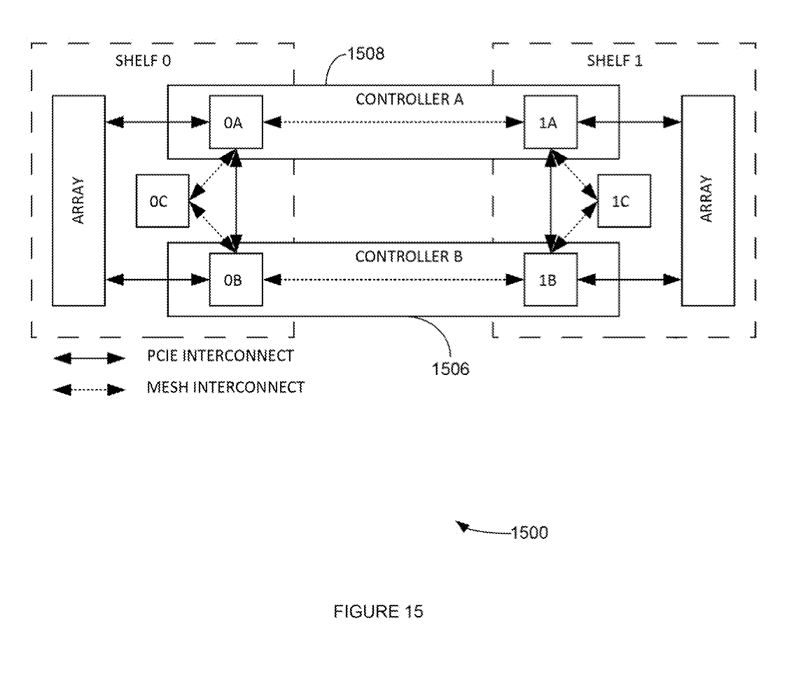

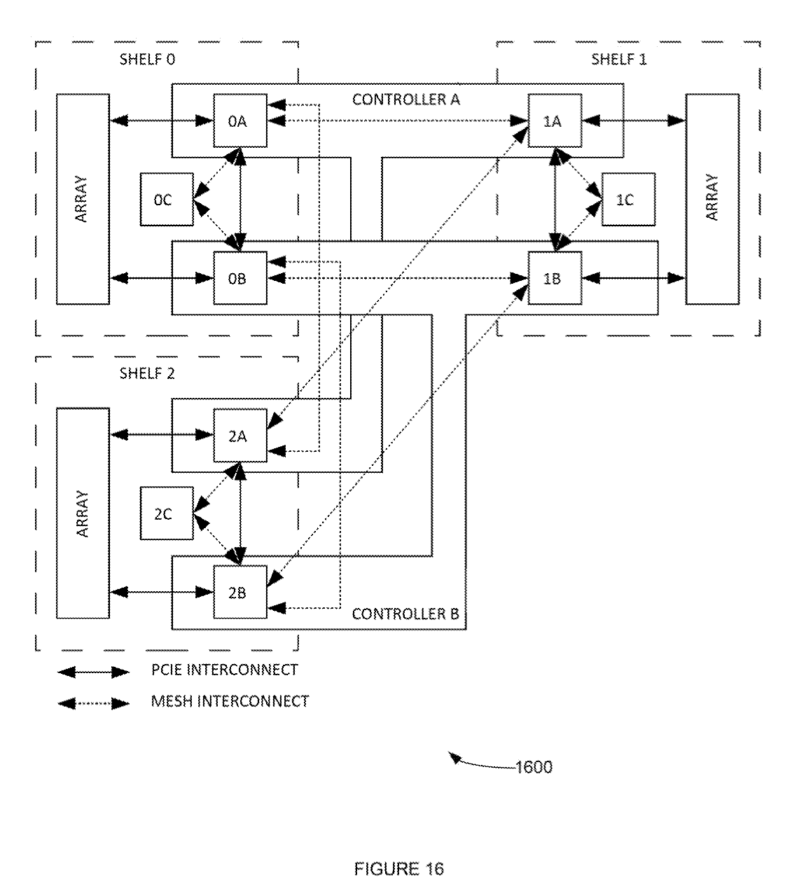

These high speed interconnects (e.g. 16 GB/sec to 32 GB/sec in some present embodiments, can be greater than 32 GB/sec), along with the interconnection to the third NVRAM module can form a mesh network between the nodes. FIGS. 15-17 illustrate example mesh interconnects with two, three and four shelves. FIG. 15 illustrates an example configuration 1500 with two ASICs attached to each controller forming nodes 0A and 1A on controller A 1508 and nodes 0B and 1B on controller B 1506. Nodes 0C and/or 1C can provide the NVRAM mirroring for each pair of ASICs. The four nodes with network HBAs attached can be active on the network and/or can receive requests. Those received by the secondary nodes (e.g. 0B and 1B) on the standby controller can be forwarded to the active nodes 0A and 1A via their direct connections. The request can be processed once it is received by an active node. For a read request, the data can be read from the appropriate node (e.g. as determined by the control plane). In one example, the read data can then be forward over the mesh interconnect for delivery to appropriate network HBA. For example, a read request on node 0B can be ‘proxied’ to node 0A. The control plane can determine that the data is to be read. For a write request, the data can be forwarded across the mesh interconnect as necessary (e.g. based on which array the control plane determined the data can be stored on). Once the data has been received by the correct active node, it can be mirrored to the corresponding local backup NVRAM. In the event of a failure of a link between nodes 0A and 0C, nodes 0A and 1A and/or nodes 1A and 1C, controller A can be deemed to have failed and controller B can become the primary controller as a failure within a controller can be treated as a controller level failure rather than just a node within it. FIG. 16 extends the configuration to three ASICs in a controller, according to some embodiments. An additional interconnect in the mesh exists such that all three ASICs can have a direct communication path between them. In example configuration 1600, any node can move data via the mesh to another node.

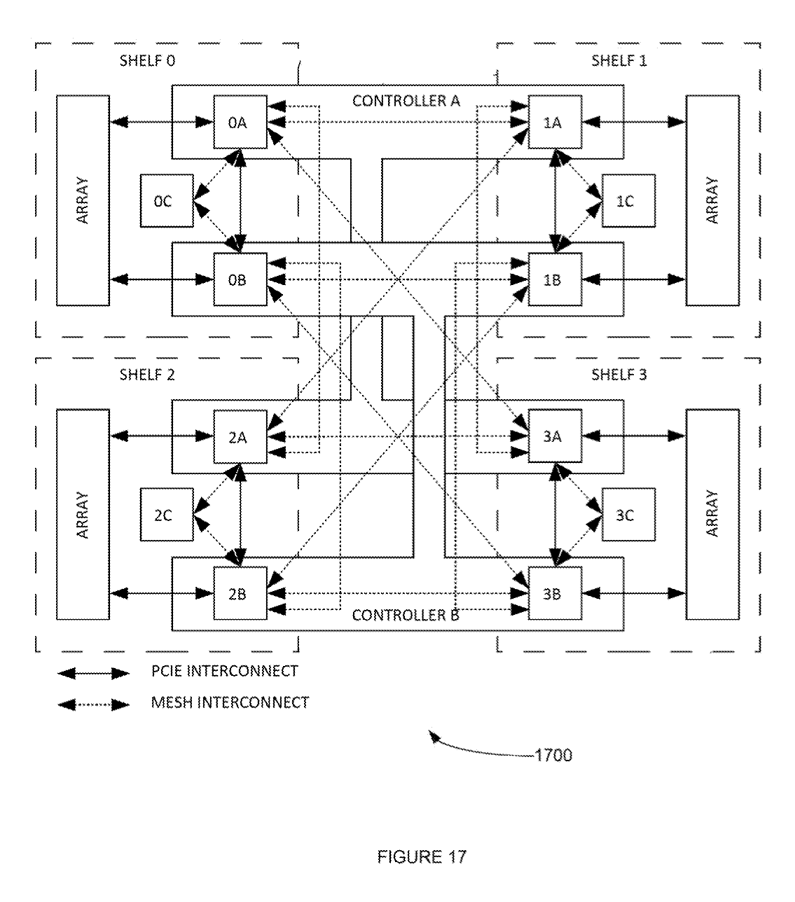

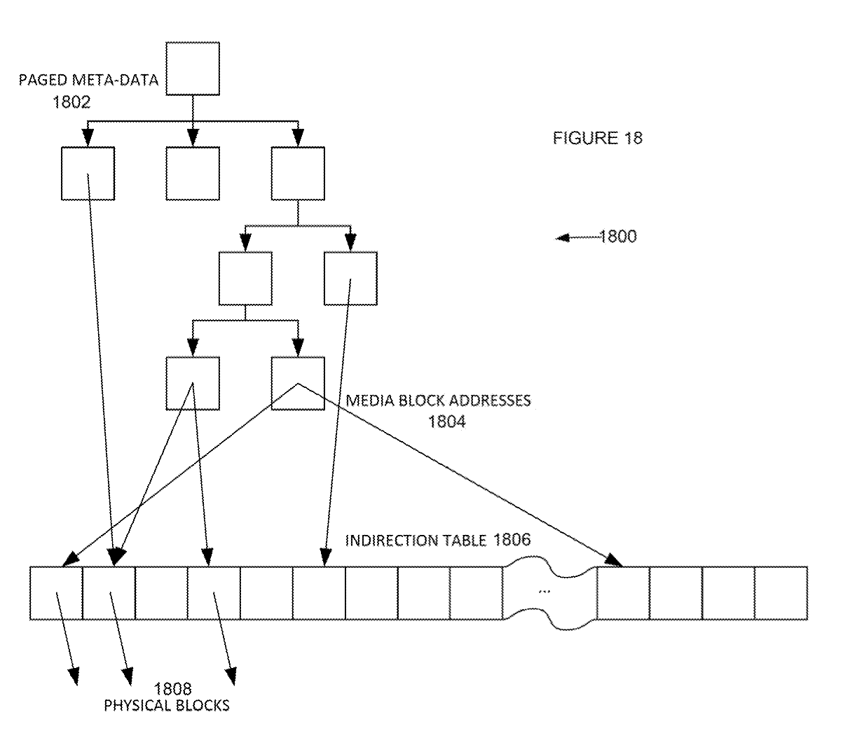

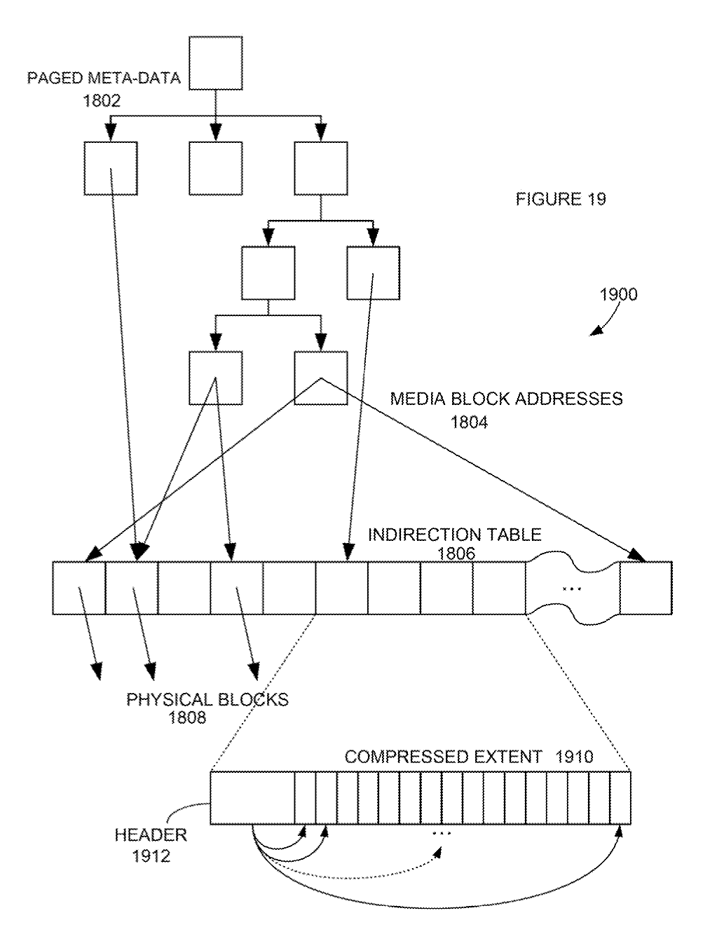

FIG. 17 further extends the example configuration to four ASICs. The maximum number of ASICs supported by the mesh can be a function of the number of interconnects provided by the ASICs. As the number of nodes increases the number of mesh lines to maintain the nodes fully connected can become a bottleneck. As each node can also support replication, the mesh interconnect can be used to move replication traffic to the correct node. Furthermore, the mesh interconnect can also be used to facilitate inter-shelf garbage collection.

Example minimal metadata for deterministic access to data with unlimited forward references and/or compression is now provided in FIGS. 18-19. Mapping LUNs, files, objects, LBAs (as well as other data structures) to the actual stored data can be managed by mapping data structures in the paged metadata memory 1802. In one example, in a system that supports compression with a given ratio (e.g. 4:1 or 8:1) then 4× or 8× the amount of metadata may be generated. Example approaches to minimize the generation of metadata are now described.

Although these data structures can maintain a mapping from the logical block addressing (LBA) to the media block address 1804, no corresponding, reverse mapping from the media block address 1804 to the LBA is maintained in some example embodiments. The mapping from LBA to media block address 1804 can be performed as this can be the primary method a read and/or write request addresses the storage. However, the reverse mapping may not be utilized for user I/O. Storage of this reverse mapping metadata can incur extra metadata as with de-duplication, snapshots etc. These reverse references can be used to allow for physical data movement within the storage array. Reverse references can have a number of uses, include, inter alia: recovery of fragmented free space (e.g. due to compression); addition of capacity to an array; removal of capacity from an array; and/or drive failover to a spare.

In order to be able to maintain data movement while limiting the reverse mappings cost, various metadata structures are now described. For example, an indirection table 1806 can be utilized. This can be a form of fixed metadata. The media address can become a logical block address on the array that indexes the indirection table 1806 to locate the actual physical address. This decoupling can enable a block to be physically moved just by updating the indirection table 1806 and/or other metadata. This indirection table 1806 can provide a deterministic approach to the data movement. As data is rewritten, entries in the indirection table 1806 can be released and/or used to store a different user data block (see system 1800 of FIG. 18).

In another example, compressed extents 1910 can be utilized (see system 1900 of FIG. 19). For example, when compressed data is to be stored, a series of physical media blocks (e.g. few, assuming say a 4K physical block size with a 1K compression granularity) can be grouped to form a compressed extent. The blocks can be mapped in the indirection table 1806 using up to an extra two bits of data to indicate the compressed extent start/end/middle blocks. It is noted that this size of the extent need not be fixed. For example, the size boundary can initiate at any physical block and terminate at any physical block. While the block size can be initially allocated in a fixed size, it can decrease at a later point in time. This larger compressed extent can be treated as a single block with regards to data movement. The extent can include a header that indicates the offsets and lengths into the extent for a number of compressed blocks (e.g. fragments). This can allows the compressed blocks to be referenced from paged metadata by a media address that represents the beginning of the compressed extent in the indirection table 1806 and an index into the header to indicate the user data starts at the ‘nth’ compressed block.

In one example, reference counting methods can be utilized. An indirection table 1806 can include multiple references to the blocks. Accordingly, reference counts of the physical blocks 1808 can be utilized. In order to track the reference counts on the compressed data, the reference counts can be tracked on the granularity of the compression unit. New references from the paged metadata (e.g. due to de-duplication, snapshots etc.) can increase the count and deletions from such metadata can reduce the count. The reference counts need not be fully stored on the compute host. Instead, the increments and/or decrements of the reference codes can be journaled. In a bulk update case (e.g. when the journal is checkpointed), the reference counts can be updated and the new counts can be stored on the array. In one example, other approaches, such as, a Lucene®-indexing system (and/or other open source information retrieval software library indexing system) and/or grouping reference counts by block range and/or count can be implemented (e.g. index segments are periodically merged).

In one example, array rebuild methods can be utilized. Array rebuilds, capacity increases or decreases can be performed by updating the indirection table 1806 and/or the reference counts. The data does not need to be decompressed and/or decrypted. Rebuilding and/or movement of data can be managed by hardware.

An example of using checksums for maintaining de-duplication database and/or parity fault location is now provided. Checksums can be used for several different purposes in various embodiments (e.g. de-duplication, read verification, etc.). In a de-duplication example, a cryptographic hash (e.g. SHA-256) can be computed for every user data block for each write. This hash can determine whether the block is already stored in the array. The hash can be seeded with tenancy/security information to ensure that the same data stored in two different user security contexts is not de-duplicated to the same physical block on the array in order to provide formal data separation. In one example, a database (e.g. A Hash database (HashDB) that is a database index that maps hashes to indirection table 1806 entries) can look up the hash in order to determine whether a block with the same data contents has already been stored on the array. The database can hold all the possible hashes in paged metadata memory. The database can use the storage devices to store the complete database. The database can utilize a cache and/or other data structures to determine whether a block already exists. HashDB can be another reference to a data block.

In a read verification example, an additional smaller checksum can be computed (e.g. substantially simultaneously with hash message authentication code (HMAC or other cryptographic hash). This checksum can be held in memory. By holding the checksum in memory, the checksum can be available so every read computes the same checksum. A comparison can be performed in order to detect transient read errors for the storage devices. A failure can result in the data being re-read from the array and/or reconstruction of the data using parity on the redundant. In some examples, the read verification checksum and a partial hash (e.g. a few bytes, but not the full length (e.g. 32 bytes with SHA-256)) can be stored together on the array in fixed metadata along with the data blocks in a redundancy unit.

Multiple reads can be implemented to validate data. For example, when the system is running the checksum database can be used to allow the data for every read to be validated to catch transient and/or drive errors. During a system start, the checksum database may not be available so the data cannot be verified. Accordingly, in order to ensure that transient errors do not go undetected, when the checksum database is not available the data can be read multiple times and/or the computed checksums can be compared to ensure that the data can be read repeatedly. Once the checksum database has been read from the media and is available, it can be used as the authoritative source of the correct checksum to compare the computed checksums against.

Various garbage collection methods can also be implemented in some example embodiments. For example, an array can be implemented in one of two modes. One array mode can include filling the full array without moving data. Another array mode can include maintaining a free space reserve where data can be moved on the storage device. Determining which array mode to implement can be based on various factors, such as: the efficiency of SSDs currently in use. In the case of one or more HDDs, a special nearest-neighbour garbage collection approach can also be implemented. The garbage collector can reclaim free space from the storage array. This can enable previously-used blocks no longer in use to be aggregated into larger pools. Example steps of the garbage collector can include, inter alia: determining a number of up-to-date reference counts; using the to up-to-date reference counts to update usage and/or allocation statistics; using the reference counts along with other hints to determine which physical blocks 1808 are the best candidates for garbage collecting; selecting whole redundancy unit chunks to be collected; copying valid uncompressed blocks to a new redundancy unit; compacting valid compressed fragments within a compressed extent; and/or relocating the reference counts and checksums for all the copied blocks and fragments to determine if there is a match. Additionally, blocks no longer referenced by other metadata but are referenced by HashDB (e.g. with a reference count of one) can have their HashDB entries removed. The entries can be located utilizing the checksum and physical location information. When a new redundancy unit has been written, an update can be performed in the indirection table 1806 that point to the new locations. The storage array can be informed that the former locations are available.

Invalid compressed and/or uncompressed blocks can be removed. As the invalid data is removed, more than one redundancy unit can be ‘garbage collected’ to create a complete unit. Alternatively incoming user data writes can be mixed with the garbage-collection data. In one example, the removal process may not utilize any lookups in the paged metadata except for removing references from HashDB. Additionally, the removal process can work with the physical data blocks as stored on the media (e.g. in an encrypted and compressed form). When compacting compressed extents 1910, the fragments can be compacted to the start of the extent. The extent header 1912 can updated to reflect to new positions. This can allow the existing media addresses in paged metadata to continue to be valid and/or to map to the compressed fragments. After compaction, the complete physical blocks 1808 at the end of the extent that no longer hold compressed fragments can store uncompressed physical blocks.

Exemplary block layout in write pipelines are now provided. Data flowing in the write pipelines can include a mixed stream of compressed and/or uncompressed data. This can be because individual data blocks can be compressed at varying ratios. The compressed blocks can be grouped together into a compressed extent. However, in some examples, this grouping can be performed as the data is streamed and/or buffered to writing to the storage array. This can be handled by a processing step at the near end of the write pipeline. In one example, it could be combined with a parity calculation step.

The input to the packing stage can track two assembly points into a large chunk unit (e.g. one for uncompressed data, and one for compressed data). Optionally, these chunks may be aligned in size to a redundancy unit. Various schemes for filling the chunk. For example, uncompressed blocks may start from the beginning and grow upwards. Compressed blocks may grow down from the end of the chunk allocating a write extent at a time. A chunk can be defined as full when no space remains available for the next block.

Compressed blocks may start from the beginning and grow upwards in extents while uncompressed blocks grow down from the end of the chunk. This scheme can result in slightly improved packing, efficiency depending on the mix of compressed and/or uncompressed data as the latter part of the last write extent could be reclaimed for uncompressed data. In a mix block example, compressed and uncompressed blocks can be intermixed. When a compressed block is written, some space can be reserved at the uncompressed assembly point for the whole compressed extent. The compressed assembly point can be used to fill up the remaining space in the write extent. Uncompressed blocks can be located after the write extent. New write extents can be created at the current uncompressed assembly point if there is no remaining extent available. In this scheme, the assembly buffer can be up to one write extent larger than the chunk size so that the chunk can be optimally filled. Spare space in a write extent (e.g. less than one uncompressed block) can be padded.

Examples of buffer layout for optimal writing are now provided. Having assembled redundant parity protected chunks, the data may not be in an optimal ordering for physical layout of the storage array. In one example, larger sequential, chunks can be written to each drive in the array. This may be done so with the smallest possible write command. The number of entries in the DMA scatter/gather list is minimized. This can be achieved by controlling the location at which the blocks that have been moved from the parity generation stage to the write-emit staging memory are placed. Physical blocks for each drive can be assembled in the parity stage when they are consecutive. When the physical blocks are moved into the butler memory, they can be remapped based on the drive geometry and/or the sequential unit written to each drive. The remapping can be performed by remapping buffer address bits and/or algorithmically computing the next address. The result can be a single DMA gather-scatter entry for each drive write. A similar mapping can be supported on the read pipeline so that larger (e.g. reads larger than a single disc block) reads can achieve the same benefit.

Examples of on-drive data copy are now provided. In cases where a number of blocks are to be moved to free up some space and those blocks still form an integral redundancy unit, it is possible to copy semantics supported by the drives to facility the movement. A copy command can be issued to the drives to copy the data to a new location without the need to transport the data out of the drive while also allow the drives to optimize the copy in terms of its own free space management. On completion of the copy, the indirection table 1806 can be updated and the original blocks can be invalidated on the media via commands such as trim. For example, this may be done in cases where the redundancy unit contains some free space (e.g. for reasons of efficiency in a loaded system).

Examples of scrubbing operations (e.g. operations such as performing background data-validation checks and/or something similar) are now provided. In order to provide extra data integrity checks and guarantees several background processes that can be utilised. For example, physical scrubbing can be performed. In one embodiment, when array bandwidth is available, entire RAID stripes can be read and parity validated along with the read status to detect storage device errors. This can operate on the compressed and/or encrypted blocks so it is also managed by hardware in some embodiments. In one example, logical scrubbing can be performed. For example, when array bandwidth and compute resources are available, paged metadata can be scanned and each stored block can be read. The relevant checksum can be validated. The scrubbing operations can be optional. Execution of scrubbing operations can be orchestrated to ensure that performance is not impacted.

The garbage collection movement and/or compaction process of the data, reference counts and checksums can be managed by hardware using a dedicated processing pipeline. This can allow garbage collection to be preformed in parallel with normal user data reads and writes without impacting performance.

Examples of pro-active replacement of SSDs to compensate for wear levelling are now provided. In one example, a method of proactively replacing drives before their end of life in a staggered fashion can be implemented. A ‘fuel gauge’ for an SSD that provides a ‘time remaining at recent write rate’ can be implemented. If any SSDs are generating errors, activities out of the normal bounds of operation and/or demonstrate signs of premature errors, the SSD's can be replaced. A back-end data collection and analytics service that collects data from deployed storage systems on an on-going basis can be implemented. Each deployed system can be examined to locate those with more than one drive at equivalent life remaining within each shelf (e.g. a RAID set). If drives in that set are approaching the last 20% of drive life or other indicator of imminent decline (e.g. at least 6-12 months before the end based on rate of fuel gauge decline or other configurable indicator) then the drives can be considered for proactive replacement.

Replacement SSDs can be installed one at a time per shelf. If they have two shelves with drives at equivalent wear that meet the above criteria, at least two drives can be installed. The number to be sent in one time however can be selected by a system administrator. Drive deployment can be staggered. On the system, a storage administrator can provide input that indicates that the ‘proactive replacement drives have arrived’ and enters the number of drives. The system can then set a drive in an offline state (e.g. one in each shelf) and indicate the drive to be replaced by a different light colour or flashing pattern on the bezel, as well as on-screen graphic showing the same.

The new drive can be installed. A background RAID rebuild can be implemented. In the case of a swapping process, the new drive online may not be brought online as a separate operation. Optionally, each drive's fuel gauge can be displayed on a front panel and/or bezel on an on-going basis. After one or more drives have been upgraded (e.g. a higher risk failure scenario has been mitigated) the drive lifetimes can be staggered. An alternative way of implementing this would be to adjust the wear times of drives prior to deployment of the array.

### Additional Systems and Architecture

FIG. 22 depicts an exemplary computing system 2200 that can be configured to perform any one of the processes provided herein. In this context, computing system 2200 may include, for example, a processor, memory, storage, and I/O devices (e.g. monitor, keyboard, disk drive, Internet connection, etc.). However, computing system 2200 may include circuitry or other specialized hardware for carrying out some or all aspects of the processes. In some operational settings, computing system 2200 may be configured as a system that includes one or more units, each of which is configured to carry out some aspects of the processes either in software, hardware, or some combination thereof.

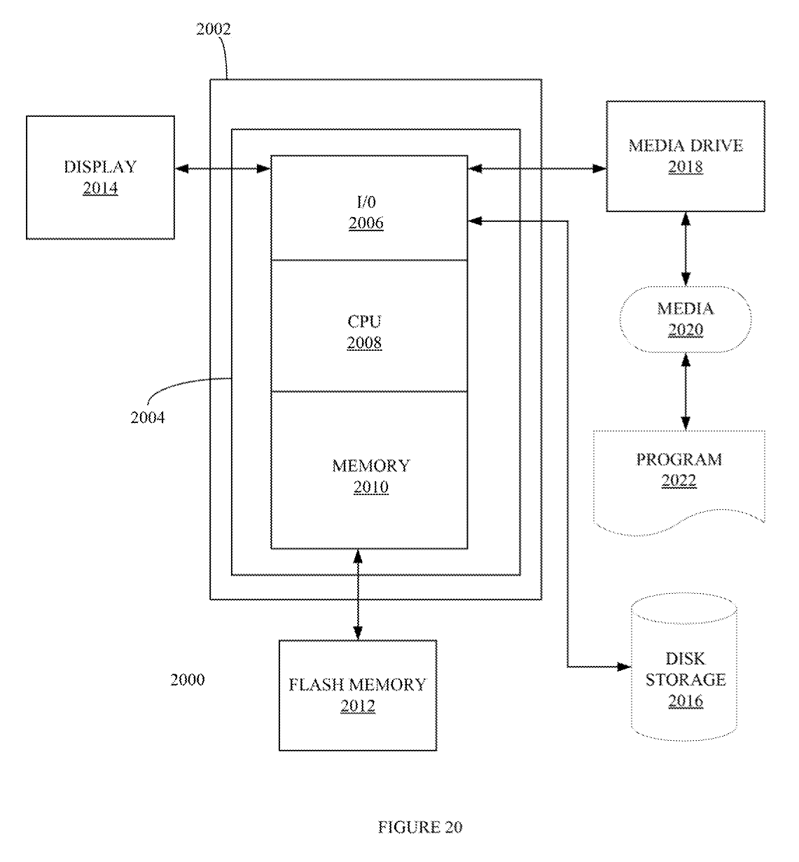

FIG. 20 depicts computing system 2000 with a number of components that may be used to perform any of the processes described herein. The main system 2002 includes a motherboard 2004 having an I/O section 2006, one or more central processing units (CPU) 2008, and a memory section 2010, which may have a flash memory card 2012 related to it. The I/O section 2006 can be connected to a display 2014, a keyboard and/or other user input (not shown), a disk storage unit 2016, and a media drive unit 2018. The media drive unit 2018 can read/write a computer-readable medium 2020, which can contain programs 2022 and/or data. Computing system 2000 can include a web browser. Moreover, it is noted that computing system 2000 can be configured to include additional systems in order to fulfill various functionalities. Computing system 2000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

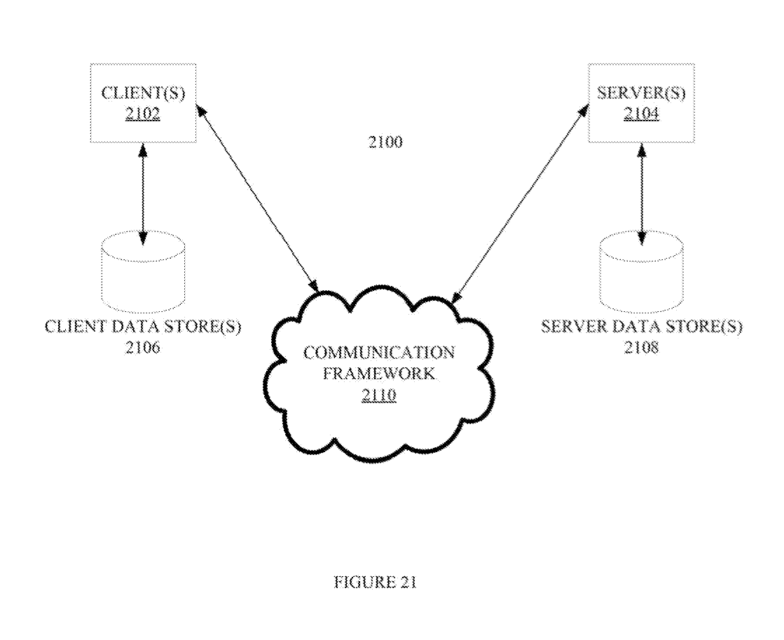

FIG. 21 is a block diagram of a sample computing environment 2100 that can be utilized to implement various embodiments. The system 2100 further illustrates a system that includes one or more client(s) 2102. The client(s) 2102 can be hardware and/or software (e.g. threads, processes, computing devices). The system 2100 also includes one or more server(s) 2104. The server(s) 2104 can also be hardware and/or software (e.g. threads, processes, computing devices). One possible communication between a client 2102 and a server 2104 may be in the form of a data packet adapted to be transmitted between two or more computer processes. The system 2100 includes a communication framework 2110 that can be employed to facilitate communications between the client(s) 2102 and the server(s) 2104. The client(s) 2102 are connected to one or more client data store(s) 2106 that can be employed to store information local to the client(s) 2102. Similarly, the server(s) 2104 are connected to one or more server data store(s) 2108 that can be employed to store information local to the server(s) 2104.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A data-plane architecture comprising:
a set of one or more memories that store a data and a metadata, wherein each memory of the set of one or more memories is split into an independent memory system;
a storage device;
a network adapter that transfers data to the set of one or more memories; and
a set of one or more processing pipelines that transform and process the data from the set of one or more memories; wherein the the one or more processing pipelines are coupled with the one or more memories, the storage device, and wherein each of the set of one or more processing pipelines comprise a programmable block for local data processing.

2. The data-plane architecture of claim 1, wherein the set of one or more memories comprises a paged metadata memory, a fixed metadata memory, a read/emit memory, a write/ingest memory and a write/emit memory.

3. The data-plane architecture of claim 2, wherein the paged metadata memory stores store metadata in a journaled or a ‘check-pointed’ data structure that is variable in size.

4. The data-plane architecture of claim 3, wherein the fixed metadata memory stores fixed-size metadata.

5. The data-plane architecture of claim 4, wherein the read/emit memory stages the data before the data is written to a network device.

6. The data-plane architecture of claim 5, wherein the write/ingest memory stages the data before the data is passed down a write pipeline.

7. The data-plane architecture of claim 6, wherein the write/emit memory stages the data before the data is written to a storage device.

8. The data-plane architecture of claim 7, wherein the set of one or pipelines comprises a write pipeline, a read pipeline, a storage-side data transform pipeline, and a network-side data transform pipeline.

9. The data-plane architecture of claim 8, wherein the write pipeline moves the data from the write/ingest memory to the write/emit memory, and wherein during the write pipeline checksums are verified ad the data is encrypted.

10. The data-plane architecture of claim 9, wherein the read pipeline transfers the data from the read/ingest memory to the read/emit memory.

11. The data-plane architecture of claim 10, wherein the storage-side data transformation pipeline implements data compaction, redundant array of independent disks (RAID) rebuilds and garbage collection operations on the data.

12. The data-plane architecture of claim 11, wherein the metadata comprises mappings from a logical unit number (LUN), a file and an object, and wherein each mapping is to a respective disc address.

13. The data-plane architecture of claim 12, wherein a memory comprises an off chip Dynamic random-access memory (DRAM), an on chip DRAM, an embedded random access memory (RAM), hybrid-memory cubes, high bandwidth memory, phase-change memory, cache memory or other similar memories.

14. The data-plane architecture of claim 13, wherein the storage device comprises a solid-state drive (SSD).

15. The data-plane architecture of claim 14, wherein the programmable block comprises a co-processor attached to a pipeline stage.
